(19) United States
(12) Patent Application Publication
(10) Pub. No.: US 2026/0134703 A1
(43) Pub. Date: May 14, 2026

(54) SYSTEM AND METHOD OF QUANTIFYING SECONDARY DENDRITE ARM SPACING

(71) Applicant: GM Global Technology Operations LLC, Detroit, MI (US)

(72) Inventors: Meysam Akbari, Macomb, MI (US); Liang Wang, Rochester Hills, MI (US); Qigui Wang, Rochester Hills, MI (US); Cuifen Yan, Rochester, MI (US)

(73) Assignee: GM Global Technology Operations LLC, Detroit, MI (US)

(21) Appl. No.: 18/945,994

(22) Filed: Nov. 13, 2024

(51) Int. Cl. G06V 20/69; G06V 10/34; G06V 10/762

(52) U.S. Cl. CPC G06V 20/69; G06V 10/34; G06V 10/762

(57) ABSTRACT

A computer-implemented method, when executed on data processing hardware, causes the data processing hardware to perform operations. The operations include i) via application of a machine learning algorithm to a micrograph representative of a metallic material, detecting clusters of dendrite arms in the metallic material and generating an image frame based on the micrograph and representative of the clusters of dendrite arms, ii) detecting, via application of a watershed algorithm to the image frame, individual dendrite arms within the clusters of dendrite arms, iii) applying at least one filter to the image frame, iv) identifying at least one cluster of dendrite arms in the image frame that satisfies the at least one filter, and v) generating, for the at least one cluster of dendrite arms, a cluster profile including at least an average dendrite arm spacing (DAS) value for the at least one cluster of dendrite arms.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to the quantification of microstructural fineness of metal castings, and more particularly to the automated quantification of dendrite arm spacing (DAS) in dendritic microstructures of metal castings.

The resulting microstructure of metallic-cast vehicular components (such as engine blocks, cylinder heads, transmission parts or the like) is determined generally by the alloy composition and more particularly by solidification conditions like local cooling rates. In many alloy compositions, the materials tend to solidify dendritically where the resulting structure contains a plurality of dendrite arms. For example, examples of alloy compositions that solidify dendritically include aluminum alloy 356 (A356) and aluminum alloy 319 (A319) among others. The relative amounts, sizes and morphology of these phases in the cast structure are highly dependent on the casting conditions as well as on the alloy composition. For example, the dendrite cell size (DCS) and DAS, sometimes referred to as secondary dendrite arm spacing (SDAS), may be used to quantify the fineness of the casting, which in turn can be used to gain a better understanding of material properties. As a general rule, cast components with smaller DAS tend to have greater durability and other mechanical properties.

Manual measurement methods of DAS may be used to determine physical properties of aluminum castings. For example, a linear intercept method may be used on a micrograph image for measuring DAS. A linear intercept method includes manually selecting three or more dendrites with visible dendrite trunks per field of view and a line is manually drawn from an outside edge of a first dendrite arm to an inside edge of a last dendrite arm. The distance for each dendrite may be recorded, while the number of dendrite arms counted for each measurement may also be recorded. These activities may be repeated for each field of view.

### SUMMARY

One aspect of the disclosure provides a computer-implemented method. The computer-implemented method, when executed on data processing hardware, causes the data processing hardware to perform operations. The operations include i) via application of a machine learning algorithm to a micrograph representative of a metallic material, detecting clusters of dendrite arms in the metallic material and generating an image frame based on the micrograph and representative of the clusters of dendrite arms, ii) detecting, via application of a watershed algorithm to the image frame, individual dendrite arms within the clusters of dendrite arms, iii) applying at least one filter to the image frame, iv) identifying at least one cluster of dendrite arms in the image frame that satisfies the at least one filter, and v) generating, for the at least one cluster of dendrite arms, a cluster profile including at least an average dendrite arm spacing (DAS) value for the at least one cluster of dendrite arms.

Implementations of this aspect of the disclosure may include one or more of the following optional features. In some examples, the at least one filter includes a distance filter requiring distances between each pair of adjacent dendrite arms of the at least one cluster of dendrite arms be between a minimum distance and a maximum distance.

In some implementations, the at least one filter includes an aspect ratio filter requiring an aspect ratio of each individual dendrite arm within the at least one cluster of dendrite arms be greater than a minimum aspect ratio.

In some configurations, the at least one filter includes an angle filter requiring angles between each pair of adjacent dendrite arms of the at least one cluster of dendrite arms be less than a maximum angle.

In some examples, the at least one filter includes a location filter requiring each individual dendrite arm within the at least one cluster of dendrite arms be positioned relative to the other dendrite arms of the at least one cluster of dendrite arms between a first bound and a second bound.

In some implementations, the at least one filter includes a quantity filter requiring that the at least one cluster of dendrite arms include at least a minimum number of individual dendrite arms.

In some configurations, the cluster profile further includes at least one selected from the group consisting of (i) a number of the at least one cluster of dendrite arms, (ii) a number of individual dendrite arms within each of the at least one cluster of dendrite arms, (iii) a width of each of the at least one cluster of dendrite arms, and (iv) an average angle of individual dendrite arms within each of the at least one cluster of dendrite arms.

In some examples, the cluster profile further includes a display image identifying the at least one cluster of dendrite arms.

In some implementations, the at least one filter is configurable based on a user input.

In some configurations, the machine learning algorithm is trained based on a plurality of annotated micrographs.

Another aspect of the disclosure provides a system. The system includes memory hardware storing instructions that, when executed on data processing hardware in communication with the memory hardware, cause the data processing hardware to perform operations. The operations include i) via application of a machine learning algorithm to a micrograph representative of a metallic material, detecting clusters of dendrite arms in the metallic material and generating an image frame based on the micrograph and representative of the clusters of dendrite arms, ii) detecting, via application of a watershed algorithm to the image frame, individual dendrite arms within the clusters of dendrite arms, iii) applying at least one filter to the image frame, iv) identifying at least one cluster of dendrite arms in the image frame that satisfies the at least one filter, and v) generating, for the at least one cluster of dendrite arms, a cluster profile including at least an average dendrite arm spacing (DAS) value for the at least one cluster of dendrite arms.

Implementations of this aspect of the disclosure may include one or more of the following optional features. In some examples, the at least one filter includes a distance filter requiring distances between each pair of adjacent dendrite arms of the at least one cluster of dendrite arms be between a minimum distance and a maximum distance.

In some implementations, the at least one filter includes an aspect ratio filter requiring an aspect ratio of each individual dendrite arm within the at least one cluster of dendrite arms be greater than a minimum aspect ratio.

In some configurations, the at least one filter includes an angle filter requiring angles between each pair of adjacent dendrite arms of the at least one cluster of dendrite arms be less than a maximum angle.

In some examples, the at least one filter includes a location filter requiring each individual dendrite arm within the at least one cluster of dendrite arms be positioned relative to the other dendrite arms of the at least one cluster of dendrite arms between a first bound and a second bound.

In some implementations, the at least one filter includes a quantity filter requiring that the at least one cluster of dendrite arms include at least a minimum number of individual dendrite arms.

In some configurations, the cluster profile further includes at least one selected from the group consisting of (i) a number of the at least one cluster of dendrite arms, (ii) a number of individual dendrite arms within each of the at least one cluster of dendrite arms, (iii) a width of each of the at least one cluster of dendrite arms, and (iv) an average angle of individual dendrite arms within each of the at least one cluster of dendrite arms.

In some examples, the cluster profile further includes a display image identifying the at least one cluster of dendrite arms.

In some implementations, the at least one filter is configurable based on a user input.

In some configurations, the machine learning algorithm is trained based on a plurality of annotated micrographs.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle;

FIG. 2A is a flowchart of a process of measuring an average dendrite arm spacing (DAS) value of a first sample according to the present disclosure;

FIG. 2B is a flowchart of a process of measuring an average DAS value of a second sample according to the present disclosure;

FIG. 2C is a flowchart of a process of measuring an average DAS value of a third sample according to the present disclosure;

FIG. 3 is a flowchart of an example watershed algorithm according to the present disclosure;

FIG. 4 is a schematic view showing an example of distance filtering for a cluster of dendrite arms according to the present disclosure;

FIG. 5 is a schematic view showing an example of aspect ratio filtering for a cluster of dendrite arms according to the present disclosure;

FIG. 6 is a schematic view showing an example of angle difference filtering for a cluster of dendrite arms according to the present disclosure;

FIG. 7 is a schematic view showing an example of arm location filtering for a cluster of dendrite arms according to the present disclosure;

FIG. 8 is a flowchart of an example method of operations for measuring an average DAS value according to the present disclosure.

FIG. 9 is a schematic view of a graphical user interface (GUI) for performing a method of measuring an average DAS value according to the present disclosure; and

FIG. 10 is a perspective view of an image analysis system that can be used to automatically quantify dendrite arm spacing according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

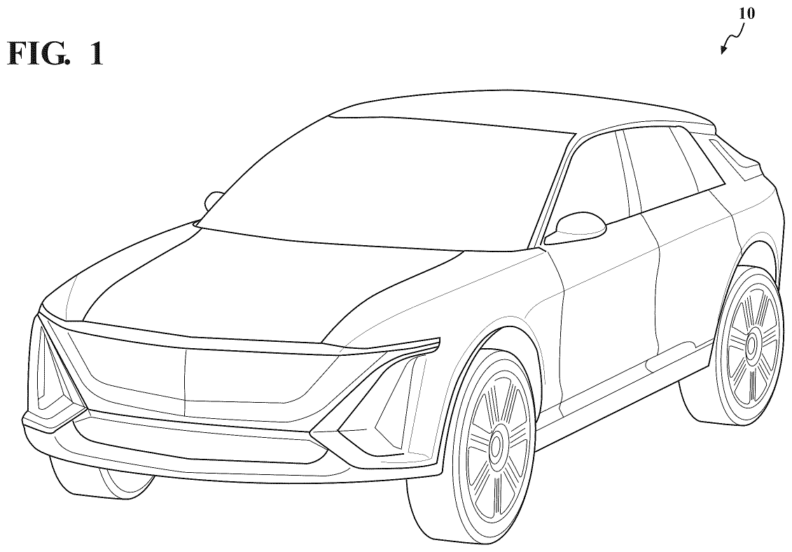

With reference to FIGS. 1-3, a vehicle 10 includes various cast metallic components, such as body panels, powertrain components, interior components, etc. that benefit from having relatively small dendrite arm spacing (DAS). For example, cast metallic components with smaller DAS tend to have better durability and related mechanical properties compared to cast metallic components with larger DAS. In this regard, cast metallic components with smaller DAS may be considered for use in the vehicle 10 compared to cast metallic components with larger DAS. The specific use case for cast metallic components included at the vehicle 10, based on the DAS, may vary depending on the specific application.

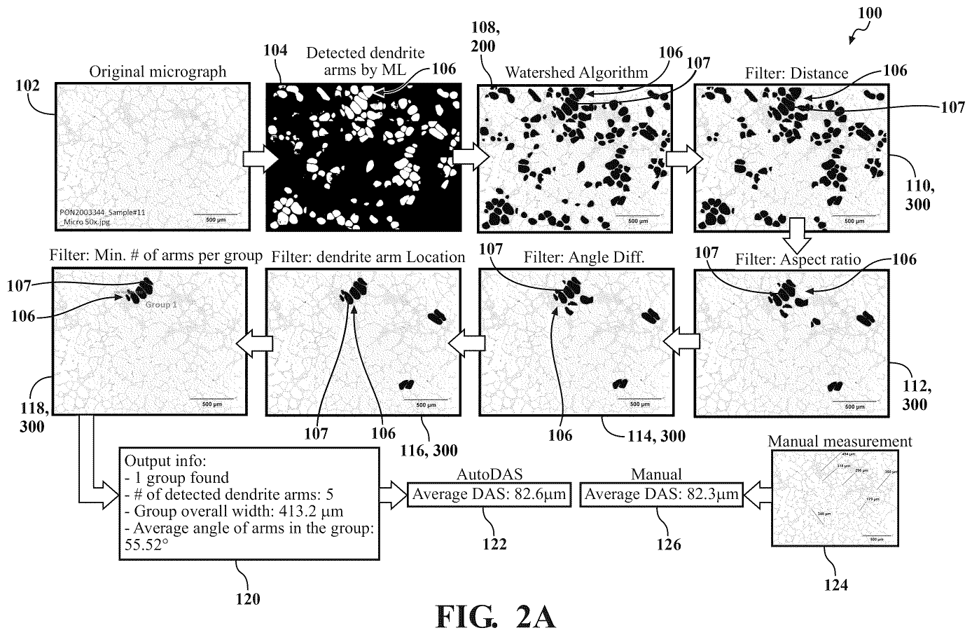

With specific reference to FIG. 2A, the process of obtaining DAS measurements to determine durability of various cast metallic components is indicated by a flowchart 100. The flowchart 100 provides illustrated examples that portray the process of obtaining DAS measurements from a micrograph 102 representative of a sample cast metallic component. It should be appreciated that the illustrated examples may differ when differing micrographs of the sample cast metallic component is provided. Further, the illustrated examples may also differ when micrographs of different samples or portions of the sample of the individual cast metallic component are provided. For example, the sample of the metallic material may be polished to obtain a flat, near mirror image surface finish. Chemical etching may be used to enhance the contrast of the dendrite structure within the sample. Each sample may be examined in numerous fields of view, each of which is subject to a high (for example, 100×) magnification, depending on the fineness of the material grain. After this, the micrograph 102 image of the field of view to be measured is captured.

The flowchart 100 begins by providing the micrograph 102 representative of a metallic material, such as, for example, aluminum or an aluminum alloy. A machine learning algorithm is applied to the micrograph 102 to produce or generate an image frame 104 based on the micrograph 102 and to detect one or more clusters 106 of dendrite arms 107 within the image frame 104. In other words, the micrograph 102 is processed via the machine learning algorithm to detect the one or more clusters 106 of dendrite arms 107 within the micrograph 102 and generate the image frame 104 representative of the micrograph 102 and the detected clusters 106. The image frame 104 may be a result of the micrograph 102 after being annotated to highlight the one or more clusters 106 of dendrite arms 107. The machine learning algorithm may be trained based on a plurality of annotated micrographs 102. The annotated micrographs 102 may be generated manually (e.g., via user inputs that indicate and/or measure the one or more clusters 106 of dendrite arms 107) and/or artificially (e.g., modified micrographs may be generated and annotated by the machine learning algorithm to increase the training data set) for training the machine learning algorithm. Moreover, the machine learning algorithm may be trained based on each additional micrograph 102 processed during operation. In other words, the machine learning algorithm improves its operation and increases its effectiveness and efficiency of detecting the clusters 106 of dendrite arms 107 as it processes an increasing quantity of image frames 104. Further details of the machine learning algorithm and its operations will be described in greater detail below.

A watershed algorithm 200 is applied to the image frame 104 to generate a watershed image frame 108. The watershed algorithm 200 detects or identifies the individual dendrite arms 107 within the clusters 106 of dendrite arms 107. Following identification of the individual dendrite arms 107, at least one filter 300 is applied to the watershed image frame 108 to identify at least one cluster 106 of dendrite arms 107 that satisfy the at least one filter 300. Because obtaining DAS measurements from the watershed image frame 108 relies on identifying at least one of the clusters 106 of dendrite arms 107 that is suitable for accurately measuring DAS, filtering the watershed image frame 108 may reduce the number of clusters 106 that qualify for further processing and may ultimately provide at least one of the clusters 106 of dendrite arms 107 that is suitable for accurately measuring DAS. The filtering specifications and standards associated with the watershed algorithm 200 will be described in greater detail below.

Although described herein as applying a plurality of filters 300 to the watershed image frame 108, it should be understood that any combination of one or more filters 300 may be applied to the watershed image frame 108. Further, although described herein as generating intermediate image frames based on the watershed algorithm 200 and the one or more filters 300, it should be understood that the processing and filtering to determine the DAS based on identified clusters of dendrite arms 107 may occur via processing of the micrograph 102 and without generating additional image frames.

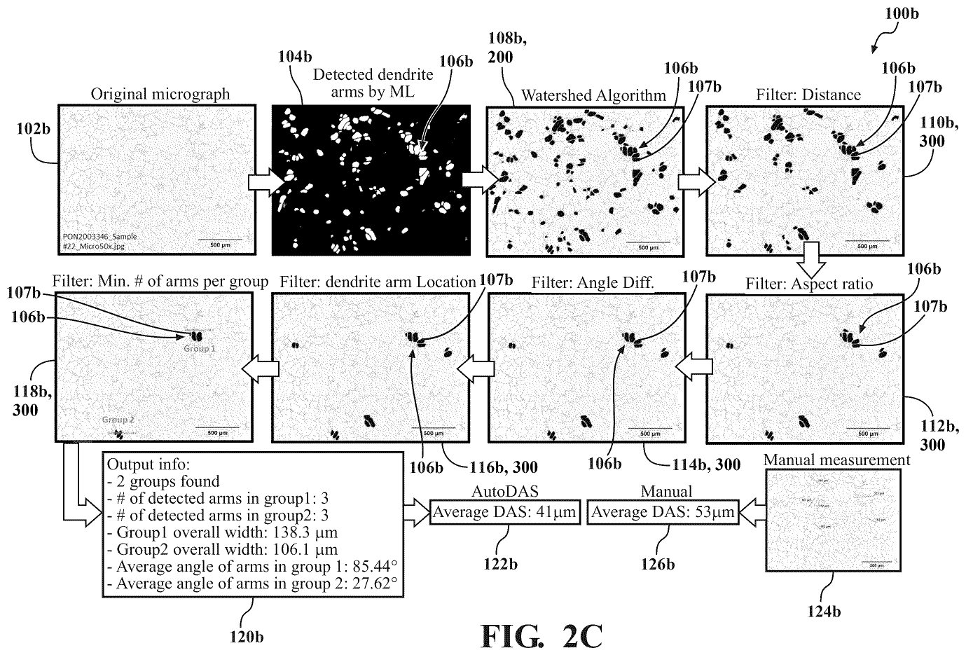

As discussed further with respect to FIG. 4, a distance filtered image frame 110 may be generated from the watershed image frame 108 after filtering the clusters 106 of dendrite arms 107 based on distance between the individual dendrite arms 107 within the clusters 106 of dendrite arms 107. In other words, a distance filter may be applied to the image frame 104 (or optionally the watershed image frame 108 and the like) to identify the clusters 106 of dendrite arms 107 that satisfy the distance filter. Distances between the individual dendrite arms 107 within the clusters 106 of dendrite arms 107 must meet specifications and requirements associated with accurately measuring DAS. The clusters 106 of dendrite arms 107 that fail the distancing filtering specifications and requirements are removed from the distance filtered image frame 110. In an opposite manner, the clusters 106 of dendrite arms 107 that pass the distancing filtering specifications and requirements are retained in the distance filtered image frame 110.

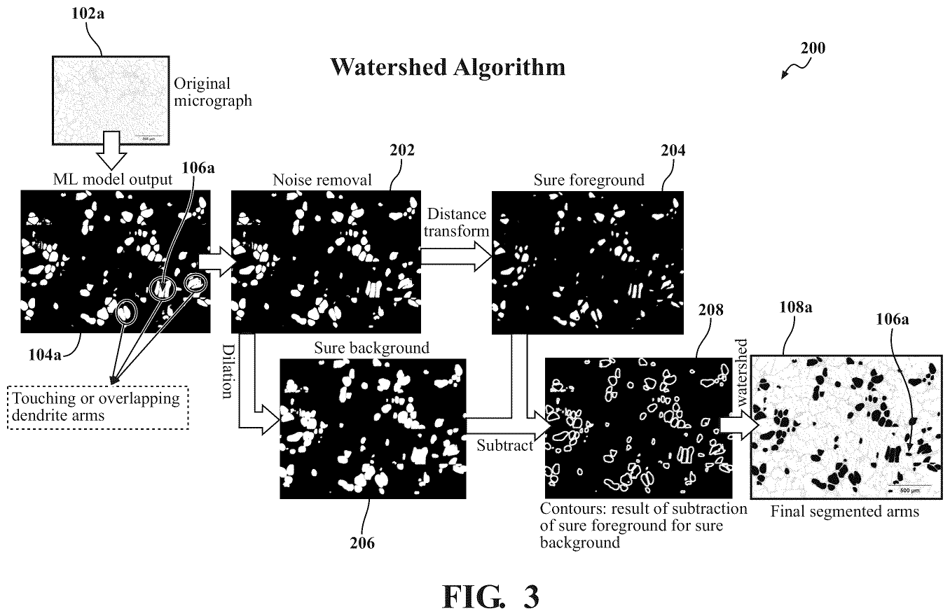

As discussed further with respect to FIG. 5, an aspect ratio filtered image frame 112 may be generated from the distance filtered image frame 110 after filtering the clusters 106 of dendrite arms 107 based on an aspect ratio of the individual dendrite arms 107 within the clusters 106 of dendrite arms 107. That is, an aspect ratio filter may be applied to the image frame 104 (or optionally the watershed image frame 108, the distance filtered image frame 110 and the like) to identify the clusters 106 of dendrite arms 107 that satisfy the distance filter. The aspect ratio of the individual dendrite arms 107 within the clusters 106 of dendrite arms 107 must meet specifications and requirements associated with accurately measuring DAS. The clusters 106 of dendrite arms 107 that fail the aspect ratio filtering specifications and requirements are removed from the aspect ratio filtered image frame 112. In an opposite manner, the clusters 106 of dendrite arms 107 that pass the aspect ratio filtering specifications and requirements are retained in the aspect ratio filtered image frame 112.

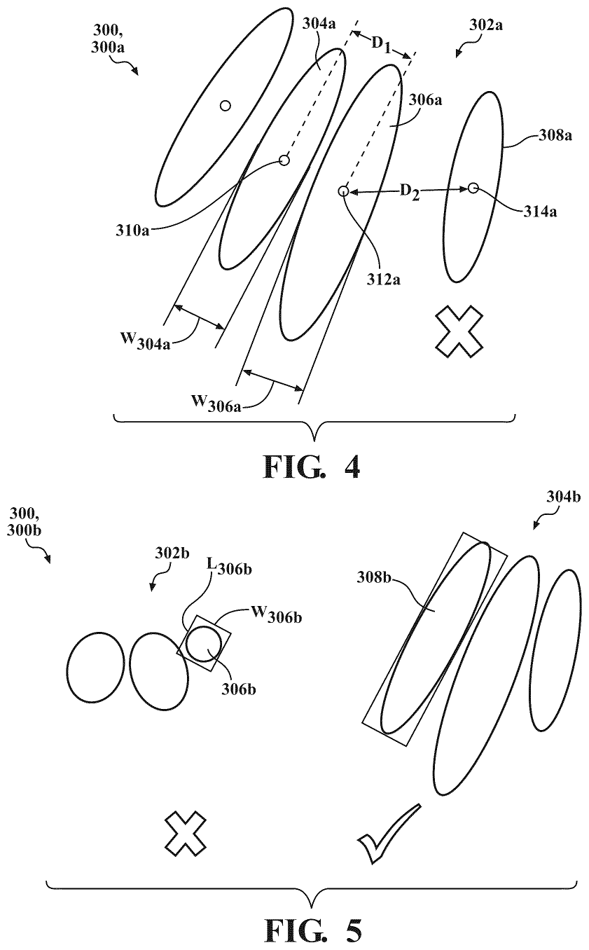

As discussed further with respect to FIG. 6, an angle filtered image frame 114 may be generated from the aspect ratio filtered image frame 112 after filtering the clusters 106 of dendrite arms 107 based on a relative angle of two adjacent dendrite arms within the clusters 106 of dendrite arms 107. Put another way, an angle filter may be applied to the image frame 104 (or optionally the watershed image frame 108, the distance filtered image frame 110, the aspect ratio filtered image frame 112 and the like) to identify the clusters 106 of dendrite arms 107 that satisfy the angle filter. The relative angle of two adjacent dendrite arms 107 within the clusters 106 of dendrite arms 107 must meet specifications and requirements associated with accurately measuring DAS. The clusters 106 of dendrite arms 107 that fail the angle filtering specifications and requirements are removed from the angle filtered image frame 114. In an opposite manner, the clusters 106 of dendrite arms 107 that pass the angle filtering specifications and requirements are retained in the angle filtered image frame 114.

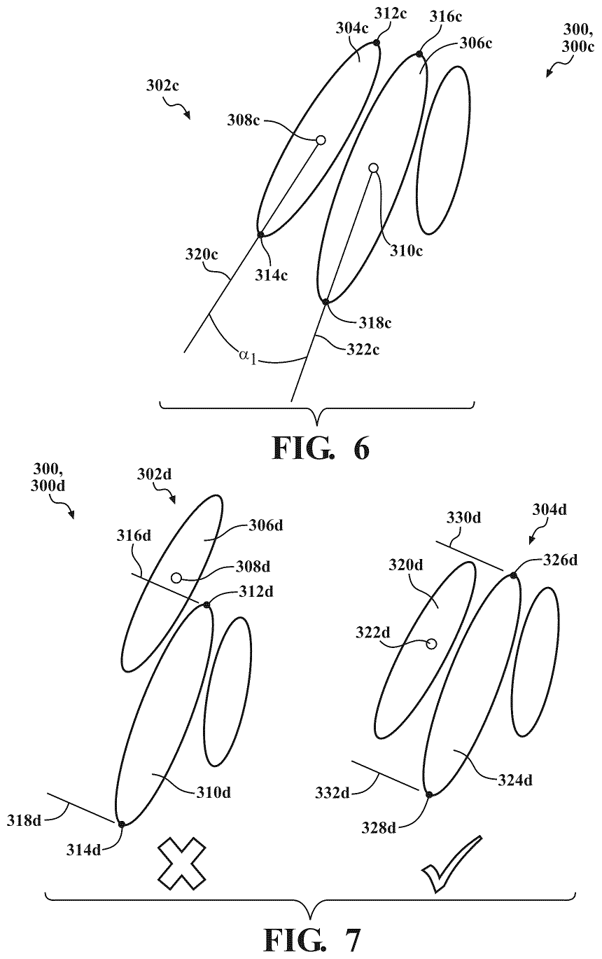

As discussed further with respect to FIG. 7, an arm location filtered image frame 116 may be generated from the angle filtered image frame 114 after filtering the clusters 106 of dendrite arms 107 based on a relative location of the individual dendrite arms 107 within the clusters 106 of dendrite arms 107. In other words, a location filter may be applied to the image frame 104 (or optionally the watershed image frame 108, the distance filtered image frame 110, the aspect ratio filtered image frame 112, the angle filtered image frame 114 and the like) to identify the clusters 106 of dendrite arms 107 that satisfy the location filter. The relative location of the individual dendrite arms 107 within the clusters 106 of dendrite arms 107 must meet specifications and requirements associated with accurately measuring DAS. The clusters 106 of dendrite arms 107 that fail the arm location filtering specifications and requirements are removed from the arm location filtered image frame 116. In an opposite manner, the clusters 106 of dendrite arms 107 that pass the arm location filtering specifications and requirements are retained in the arm location filtered image frame 116.

Moreover, an arm quantity filtered image frame 118 may be generated from the arm location filtered image frame 116 after filtering the clusters 106 of dendrite arms 107 based on a quantity of the individual dendrite arms 107 within the clusters 106 of dendrite arms 107. That is, a quantity filter may be applied to the image frame 104 (or optionally the watershed image frame 108, the distance filtered image frame 110, the aspect ratio filtered image frame 112, the angle filtered image frame 114, the arm location filtered image frame 116 and the like) to identify the clusters 106 of dendrite arms 107 that satisfy the quantity filter. The quantity of the individual dendrite arms 107 within the clusters 106 of dendrite arms 107 must meet specifications and requirements associated with accurately measuring DAS. The clusters 106 of dendrite arms 107 that fail the arm quantity filtering specifications and requirements are removed from the arm quantity filtered image frame 118. In an opposite manner, the clusters 106 of dendrite arms 107 that pass the arm quantity filtering specifications and requirements are retained in the arm quantity filtered image frame 118. The clusters 106 of dendrite arms 107 that remain in the arm quantity filtered image frame 118 are suitable for accurately measuring DAS.

A cluster profile 120 is generated for the clusters 106 of dendrite arms 107 that remain in the arm quantity filtered image frame 118 since the clusters 106 of dendrite arms 107 in the arm quantity filtered image frame 118 are suitable for accurately measuring DAS. However, it should be appreciated that the order and sequence of filtering the clusters 106 of dendrite arms 107 may vary without deviating from the context of this disclosure. For example, if the arm location filtered image frame 116 is generated after the arm quantity filtered image frame 118 is generated, and arm location filtering is the final filter applied to the clusters 106 of dendrite arms 107, the cluster of dendrite arms 107 remaining in the arm location filtered image frame 116 are suitable for accurately measuring DAS. Put another way, the cluster profile 120 is generated for the at least one cluster 106 of dendrite arms 107 that satisfy the at least one filter 300 applied to the image frame 104.

The cluster profile 120 includes at least an average DAS 122 for at least one of the clusters 106 of dendrite arms 107 that satisfy each of the filters 300. The average DAS 122 is automatically generated from the individual dendrite arms 107 provided in each of the clusters 106 of dendrite arms 107 that satisfy each of the filters 300. In this example, the average DAS 122 determined from the micrograph 102 is 82.6 micrometers. The cluster profile 120 may also include, but is not limited to, i) a quantity of the clusters 106 of dendrite arms 107 that satisfy each of the filters 300, ii) a quantity of the individual dendrite arms 107 within the clusters 106 of dendrite arms 107 that satisfy each of the filters 300, iii) an overall width of the clusters 106 of dendrite arms 107 that satisfy each of the filters 300, and iv) an average angle of the individual dendrite arms 107 within the clusters 106 of dendrite arms 107 that satisfy each of the filters 300. In the illustrated example of FIG. 2A, one cluster 106 of dendrite arms 107 satisfies each of the filters 300 and the one cluster 106 includes five individual dendrite arms 107 with an overall width of 413.2 micrometers and an average angle of 55.52 degrees.

In contrast, a manually measured micrograph 124 relies on a user manually selecting the clusters 106 of dendrite arms 107 that are supposedly suitable for measuring DAS. Manually selecting the clusters 106 of dendrite arms 107 that are supposedly suitable for measuring DAS may be less suitable than the clusters 106 of dendrite arms 107 identified as a result of applying the one or more filters 300 to the watershed image frame 108. As a result, a manually measured average DAS 126 derived from the clusters 106 of dendrite arms 107 manually identified in the manually measured micrograph 124 may be less accurate than the average DAS 122 that is automatically generated.

As stated above, the illustrated examples may differ when micrographs of differing cast metallic components are provided. Further, the illustrated examples may also differ when different micrographs of an individual cast metallic component are provided. With specific reference to FIG. 2B, a second flowchart 100a is provided that includes a micrograph 102a that represents another sample of a cast metallic component than the micrograph 102 included in the flowchart 100. However, functions and operations of the second flowchart 100a are substantially similar to functions and operations of the flowchart 100 as described above.

For example, the machine learning algorithm produces an image frame 104a based on the micrograph 102a and detects clusters 106a of dendrite arms 107a within the image frame 104a. The watershed algorithm 200 is applied to the image frame 104a to generate a watershed image frame 108a that identifies the individual dendrite arms 107a within the clusters 106a of dendrite arms 107a. At this point, the one or more filters 300 as described above may be applied to the image frame 104a or the watershed image frame 108a to determine one of more of the clusters 106a of dendrite arms 107a that are suitable for DAS measurement. The one or more filters 300 may generate a distance filtered image frame 110a, an aspect ratio filtered image frame 112a, an angle filtered image frame 114a, an arm location filtered image frame 116a, and/or an arm quantity filtered image frame 118a to determine the one more clusters 106a of dendrite arms 107a that satisfy each of the filters 300.

A cluster profile 120a is generated for the one or more clusters 106a of dendrite arms 107a that remain in the arm quantity filtered image frame 118a since the clusters 106a of dendrite arms 107a in the arm quantity filtered image frame 118a satisfy each of the one or more filters 300 and are suitable for accurately measuring DAS. The cluster profile 120a includes at least an average DAS 122a for at least one of the clusters 106a of dendrite arms 107a remaining in the arm quantity filtered image frame 118a. In this example, the average DAS 122a determined from the micrograph 102a is 72 micrometers. Moreover, the cluster profile 120a indicates that one cluster 106a of dendrite arms 107a satisfies each of the at least one filter 300 and the one cluster 106a includes three individual dendrite arms 107a with an overall width of 215.8 micrometers and an average angle of 9.31 degrees. A manually measured average DAS 126a derived from the clusters 106a of dendrite arms 107a manually identified in a manually measured micrograph 124a may be less accurate than the average DAS 122a that is automatically generated.

With specific reference to FIG. 2C, a third flowchart 100b is provided that includes a micrograph 102b that represents another sample of a cast metallic component than the micrograph 102 included in the flowchart 100. However, functions and operations of the third flowchart 100b are substantially similar to functions and operations of the flowchart 100 as described above.

For example, the machine learning algorithm produces an image frame 104b based on the micrograph 102b and detects clusters 106b of dendrite arms 107b within the image frame 104b. The watershed algorithm 200 is applied to the image frame 104b to generate a watershed image frame 108b that identifies individual dendrite arms 107b within the clusters 106b of dendrite arms 107b. At this point, the one or more filters 300 as described above may be applied to the image frame 104b or the watershed image frame 108b to determine one of more of the clusters 106b of dendrite arms 107b that are suitable for DAS measurement. The one or more filters 300 may generate a distance filtered image frame 110b, an aspect ratio filtered image frame 112b, an angle filtered image frame 114b, an arm location filtered image frame 116b, and/or an arm quantity filtered image frame 118b to determine the one or more clusters 106b of dendrite arms 107b that satisfy each of the one or more filters 300.

A cluster profile 120b is generated for the one or more clusters 106b of dendrite arms 107b that remain in the arm quantity filtered image frame 118b since the clusters 106b of dendrite arms 107b in the arm quantity filtered image frame 118b satisfy each of the one or more filters 300 and are thus suitable for accurately measuring DAS. The cluster profile 120b includes at least an average DAS 122b for each of the clusters 106b of dendrite arms 107b remaining in the arm quantity filtered image frame 118b. In this example, the average DAS 122b determined from the micrograph 102b is 41 micrometers. Further, the cluster profile 120b indicates that two clusters 106b of dendrite arms 107b satisfy each of the at least one filter 300 with one cluster 106b including three individual dendrite arms with an overall width of 138.3 micrometers and an average angle of 85.44 degrees and another cluster 106b including three individual dendrite arms with an overall width of 107.1 micrometers and an average angle of 27.62 degrees. A manually measured average DAS 126b derived from the clusters 106b of dendrite arms 107b manually identified in a manually measured micrograph 124b may be less accurate than the average DAS 122b that is automatically generated.

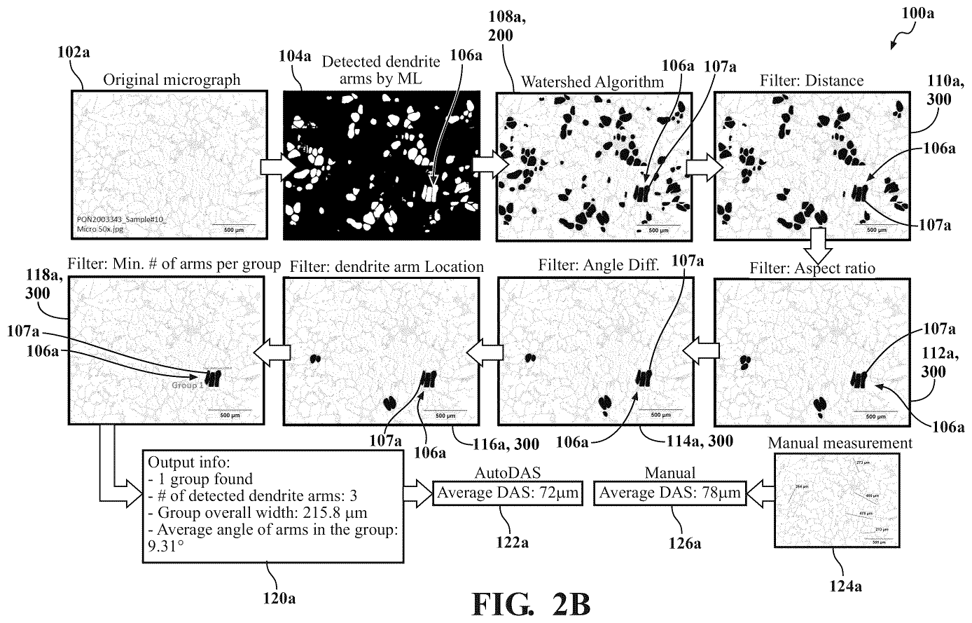

With specific reference to FIG. 3, the watershed algorithm 200 identifies individual dendrite arms 107a within the clusters 106a of dendrite arms 107a. While the illustrated examples provided in FIG. 3 correspond to frames included in the second flowchart 100a, it should be appreciated that the watershed algorithm 200 may be applied in substantially similar manner at frames in the flowchart 100, frames in the third flowchart 100b, or frames representative of any portions of any cast metallic components, without deviating from the context of this disclosure. The image frame 104a generated from the micrograph 102a may include individual dendrite arms 107a within the clusters 106a of dendrite arms 107a that touch or overlap. Touching or overlapping individual dendrite arms 107a may pose challenges to accurately measuring DAS. Therefore, the watershed algorithm 200 performs actions to allow individual dendrite arms 107a with the clusters 106a of dendrite arms 107a to be accurately measured.

For example, a noise removal frame 202 is derived from the image frame 104a. The noise removal frame 202 removes various occurrences of extremely small or isolated individual dendrite arms that pose little to no significance in DAS measurements. By transforming distances between the individual dendrite arms 107a of the clusters 106a of dendrite arms 107a, a sure foreground frame 204 is generated from the noise removal frame 202. Also generated from the noise removal frame 202 is a sure background frame 206 that dilates the individual dendrite arms 107a of the clusters 106a of dendrite arms 107a. Subtracting the sure foreground frame 204 from the sure background frame 206 results in a contour frame 208. The contour frame 208 includes the clusters 106a of dendrite arms 107a that clearly isolate individual dendrite arms 107a, thus allowing the individual dendrite arms 107a to be visualized more clearly compared to what is provided in the image frame 104a. Finally, the watershed image frame 108a is generated based on the contour frame 208, such as by overlaying the contour frame 208 atop the micrograph 102a to outline the individual dendrite arms 107a identified by the contour frame 208. The watershed image frame 108a includes the individual dendrite arms 107a of the clusters 106a of dendrite arms 107a that are clearly identifiable, thus assisting in subsequent filtering applied to the watershed image frame 108a.

With reference to FIGS. 4-7, as stated above, the at least one filter 300 is applied to the clusters 106 of dendrite arms 107 identified in the watershed image frame 108. For example, and with specific reference to FIG. 4, the at least one filter 300 may include a distance filter 300a. The distance filter 300a generates the distance filtered image frame 110 at the flowchart 100 and requires distances between each pair of adjacent dendrite arms 107 of the at least one cluster 106 of dendrite arms 107 be between a minimum distance and a maximum distance. In the illustrated example, an example cluster 302a includes a first dendrite arm 304a, a second dendrite arm 306a, and a third dendrite arm 308a. The first dendrite arm 304a is adjacent to the second dendrite arm 306a, while the second dendrite arm 306a is adjacent to the third dendrite arm 308a. The first dendrite arm 304a includes a first center point 310a that is centered within the first dendrite arm 304a along a longitudinal axis of the first dendrite arm 304a. The second dendrite arm 306a includes a second center point 312a that is centered within the second dendrite arm 306a along a longitudinal axis of the second dendrite arm 306a. The third dendrite arm 308a includes a third center point 314a that is centered within the third dendrite arm 308a along a longitudinal axis of the third dendrite arm 308a. In other words, the center points of the dendrite arms may be positioned in respective central regions of the dendrite arms along their longest axes.

The first dendrite arm 304a includes a first width W₃₀₄ₐ measured at a widest point of the first dendrite arm 304a perpendicular to the longitudinal axis, and the second dendrite arm 306a includes a second width W₃₀₆ₐ measured at a widest point of the second dendrite arm 306a perpendicular to the longitudinal axis. A first distance D₁ between the first center point 310a and the second center point 312a must be greater than an average of the first width W₃₀₄ₐ and the second width W₃₀₆ₐ to satisfy the distance filter 300a. The first distance D₁ may be measured as the shortest distance between the first center point 310a and the second center point 312a measured along any axis. In other words, the first distance D₁ between the first center point 310a and the second center point 312a must be greater than the first width W₃₀₄ₐ added to the second width W₃₀₆ₐ and divided by two. In some examples, the first distance D₁ must be less than the average of the first width W₃₀₄ₐ and the second width W₃₀₆ₐ multiplied by a distance scale factor to satisfy the distance filter 300a. The distance scale factor may be user configurable. In this regard, the first dendrite arm 304a and the second dendrite arm 306a meet the requirements of the distance filter 300a, since the first distance D₁ is within the bounds of the distance filter 300a as described above. However, a second distance D₂ between the second center point 312a and the third center point 314a falls outside the bounds of the distance filter 300a as described above. As a result, the third dendrite arm 308a is filtered out and removed from the distance filtered image frame 110. The second distance D₂ may be measured as the shortest distance between the second center point 312a and the third center point 314a measured along any axis.

That is, to satisfy the distance filter 300a, the distance D₁ between dendrite arms within the cluster must be greater than the average width of the dendrite arms and less than the average width of the dendrite arms multiplied by a scale factor (F). Where the coordinates of the first dendrite arm 304a are represented as (x₃₀₄ₐ, y₃₀₄ₐ) and the coordinates of the second dendrite arm 306a are represented as (x₃₀₆ₐ, y₃₀₆ₐ), satisfying the distance filter 300a can be represented by

$$\frac{{W}_{304 a} + {W}_{306 a}}{2} < {D}_{1} = \sqrt{{( {x}_{306 a} - {x}_{304 a} )}^{2} - {( {y}_{306 a} - {y}_{304 a} )}^{2}} < F \frac{{W}_{304 a} + {W}_{306 a}}{2}$$

In another example, and with specific reference to FIG. 5, the at least one filter 300 may include an aspect ratio filter 300b. The aspect ratio filter 300b generates the aspect ratio filtered image frame 112 at the flowchart 100 and requires an aspect ratio of each individual dendrite arm 107 within the at least one cluster 106 of dendrite arms 107 be greater than a minimum aspect ratio. The minimum aspect ratio may be user configurable and is determined based on a length of an individual dendrite arm 107 divided by a width of the individual dendrite arm 107. The aspect ratio filter 300b requires the length of the dendrite arms to be longer than the width of the dendrite arms based on the minimum aspect ratio, such as 1.5 to 1, 2 to 1, 3 to 1, and the like. In the illustrated example, a first example cluster 302b and a second example cluster 304b are provided. The first example cluster 302b includes a first dendrite arm 306b, and the second example cluster 304b includes a second dendrite arm 308b.

The first dendrite arm 306b includes a length L_{306b} and a width W_{306b} that are close or identical to one another. For example, the first dendrite arm 306b may be circular or close to circular. The length L_{306b} divided by the width W_{306b} of the first dendrite arm 306b is less than the minimum aspect ratio. As a result, the first dendrite arm does not satisfy the aspect ratio filter 300b and may be removed from the aspect ratio filtered image frame 112. The second dendrite arm 308b includes a length L_{308b} that is substantially greater than a width W_{308b} of the second dendrite arm 308. For example, the second dendrite arm 308b may have an elongated shape. The length L_{308b} divided by the width W_{308b} of the second dendrite arm 308b is greater than the minimum aspect ratio. As a result, the second dendrite arm 308b may satisfy the aspect ratio filter 300b and may remain in the aspect ratio filtered image frame 112.

In another example, and with specific reference to FIG. 6, the at least one filter 300 may include an angle filter 300c. The angle filter 300c generates the angle filtered image frame 114 at the flowchart 100 and requires angles between each pair of adjacent dendrite arms 107 of the at least one cluster 106 of dendrite arms 107 be less than a maximum angle. In the illustrated example, an example cluster 302c includes a first dendrite arm 304c and a second dendrite arm 306c that are adjacent to one another. The first dendrite arm 304c includes a first center point 308c that is centered within the first dendrite arm 304c along a first major axis 320c of the first dendrite arm 304c. The second dendrite arm 306c includes a second center point 310c that is centered within the second dendrite arm 306c along a second major axis 322c of the second dendrite arm 306c. Further, the first dendrite arm 304c includes a first vertex point 312c at an end of the first dendrite arm 304c and a second vertex point 314c at an opposite end of the first dendrite arm 304c from the first vertex point 312c. The second dendrite arm 306c includes a third vertex point 316c at an end of the second dendrite arm 306c and a fourth vertex point 318c at an opposite end of the second dendrite arm 306c from the third vertex point 316c. The longitudinal axis 320c intersects the first vertex point 312c and the second vertex point 314c of the first dendrite arm 304c, while the second major axis 322c intersects the third vertex point 316c and the fourth vertex point 318c of the second dendrite arm 306c.

A dendrite arm angle α₁ is defined by the first major axis 320c relative to the second major axis 322c. The dendrite arm angle α₁ must be less than the maximum angle for the first dendrite arm 304c and the second dendrite arm 306c to satisfy the angle filter 300c. The maximum angle may be user configurable. For example, the maximum angle may be 5 degrees or less, 10 degrees or less, 20 degrees or less, 30 degrees or less, and the like. If the dendrite arm angle α₁ is greater than the maximum angle, the first dendrite arm 304c and the second dendrite arm 306c fail to satisfy the angle filter 300c and may be removed from the angle filtered image frame 114. In this regard, each pair of adjacent dendrite arms within the clusters of dendrite arms 107 must be relatively parallel, or close to parallel, to one another, depending on the configurable maximum angle.

In another example, and with specific reference to FIG. 7, the at least one filter 300 may include an arm location filter 300d. The arm location filter 300d generates the arm location filtered image frame 116 at the flowchart 100 and requires each individual dendrite arm 107 within the at least one cluster 106 of dendrite arms 107 be positioned relative to the other dendrite arms 107 of the at least one cluster 106 of dendrite arms 107 between a first bound and a second bound. For example, the center points of the respective dendrite arms 107 within the cluster 106 must be substantially aligned with one another to satisfy the arm location filter 300d. In the illustrated example, a first example cluster 302d and a second example cluster 304d are provided. The first example cluster 302d includes a first dendrite arm 306d that includes a first center point 308d that is centered within the first dendrite arm 306d along a longitudinal axis of the first dendrite arm 306d. The first example cluster 302d also includes a second dendrite arm 310d that includes a first vertex point 312d at an end of the second dendrite arm 310d and a second vertex point 314d at an opposite end of the second dendrite arm 310d from the first vertex point 312d. In this example, the second dendrite arm 310d has a length greater than all other dendrite arms included in the first example cluster 302d.

A first bounding line 316d extends from the first vertex point 312d and is perpendicular to the longitudinal axis of the second dendrite arm 310d. In a similar manner, a second bounding line 318d extends from the second vertex point 314d and is perpendicular to the longitudinal axis of the second dendrite arm 310d. In this regard, the first bounding line 316d and the second bounding line 318d are parallel to one another. The first center point 308d of the first dendrite arm 306d is positioned outside the bounds of the first bounding line 316d and the second bounding line 318d. As a result, the first dendrite arm 306d fails the requirements of the arm location filter 300d. The arm location filter 300d removes and filters out the first dendrite arm 306d at the arm location filtered image frame 116.

The second example cluster 304d includes a third dendrite arm 320d that includes a third center point 322d that is centered within the third dendrite arm 320d along a longitudinal axis of the third dendrite arm 320d. The second example cluster 304d also includes a fourth dendrite arm 324d that includes a third vertex point 326d at an end of the fourth dendrite arm 324d and a fourth vertex point 328d at an opposite end of the fourth dendrite arm 324d from the third vertex point 326d. In this example, the fourth dendrite arm 324d has a length greater than all other dendrite arms included in the second example cluster 304d.

A third bounding line 330d extends from the third vertex point 326d and is perpendicular to the longitudinal axis of the fourth dendrite arm 324d. In a similar manner, a fourth bounding line 332d extends from the fourth vertex point 328d and is perpendicular to the longitudinal axis of the fourth dendrite arm 324d. In this regard, the third bounding line 330d and the fourth bounding line 332d are parallel to one another. The third center point 322d of the third dendrite arm 320d is positioned within the bounds of the third bounding line 330d and the fourth bounding line 332d. As a result, the third dendrite arm 320d satisfies the arm location filter 300d. The arm location filter 300d retains and includes the third dendrite arm 320d at the arm location filtered image frame 116. In other words, the arm location filter 300d may require the center points of all dendrite arms within the cluster to be positioned within bounds established by vertex points of the largest dendrite arm of the cluster. Optionally, the ends or vertex points of each dendrite arm within the cluster must be within the bounds established by the vertex points of the largest dendrite arm to satisfy the arm location filter 300d.

For example, where the third bounding line 330d is represented by a linear equation

$$y = ax + {b}_{2}$$

and the fourth bounding line 332d is represented by a linear equation

$$y = ax + {b}_{1}$$

and where the coordinates of the third dendrite arm 320d are represented as (x_{320d}, y_{320d}), satisfying the arm location filter 300d can be represented by

$$\frac{{y}_{320 d} - {b}_{1}}{a} < {x}_{320 d} < \frac{{y}_{320 d} - {b}_{2}}{a}$$

In another example, the at least one filter 300 may include an arm quantity filter (not shown). The arm quantity filter generates the arm quantity filtered image frame 118 at the flowchart 100 and requires that the at least one cluster 106 of dendrite arms 107 include at least a minimum number of individual dendrite arms 107. The minimum number of the individual dendrite arms 107 within the at least one cluster 106 of dendrite arms 107 may be user configurable. The clusters 106 of dendrite arms 107 that include less individual dendrite arms 107 than the minimum number of individual dendrite arms 107 fail to satisfy the quantity filter and may be filtered out and removed from the arm quantity filtered image frame 118.

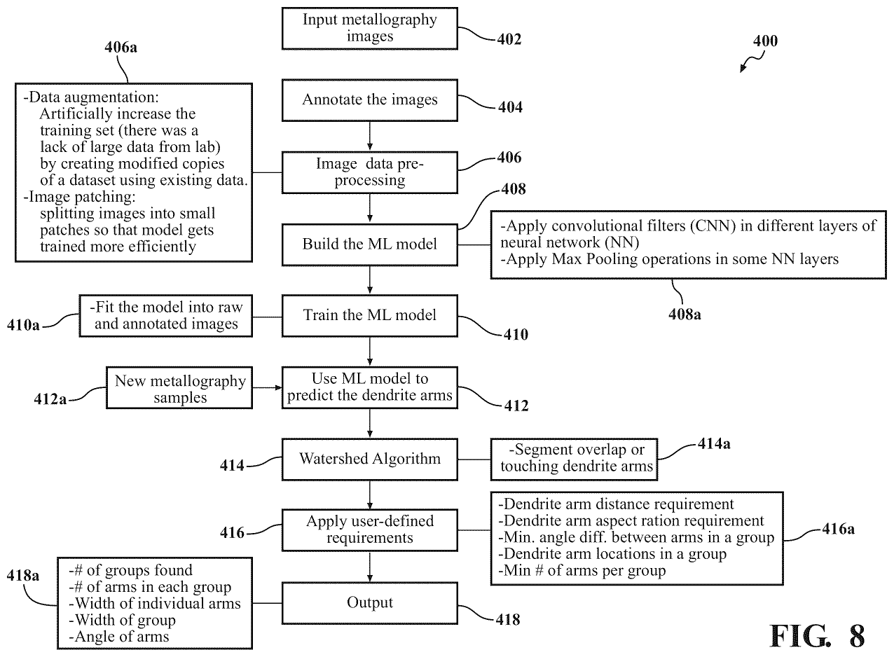

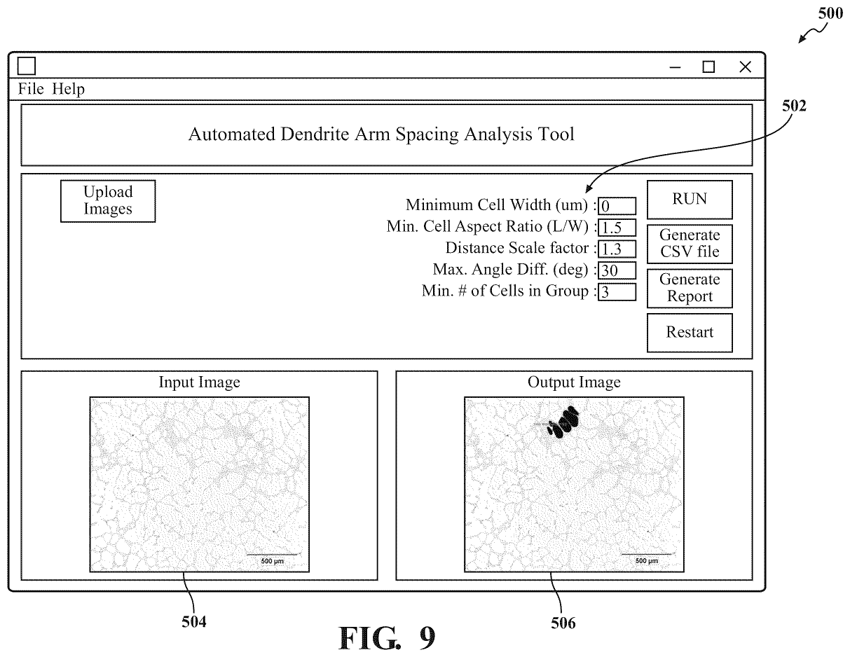

With reference to FIG. 8, a method 400 of generating the cluster profile 120 includes, at operation 402, initiating the machine learning algorithm by inputting metallography images, such as the micrograph 102, that are representative of a cast metallic component. At operation 404, the method includes annotating the metallography images, such as the image frames 104, thus detecting the clusters 106 of dendrite arms 107. Image data pre-processing occurs at operation 406 of the method 400, which may further include operation 406a. For example, operation 406a may include data augmentation that artificially increases the quantity of the image frames 104 for training the machine learning algorithm via creating modified copies using pre-existing data. Further, image patching occurs at operation 406a by splitting the image frames 104 into small patches so the machine learning model can train more efficiently. At operation 408, the method 400 includes building the machine learning model, which may further include operation 408a. For example, operation 408a includes applying convolutional filters (CNN) at different layers of a neural network (NN), with max pooling operations occurring at some layers of the NN. The machine learning model is trained at operation 410 of the method 400, which may further include operation 410a. Operation 410a of the method includes incorporating the machine learning model with raw images, such as the micrographs 102, with annotated images, such as the image frames 104.

At operation 412, the method 400 includes applying the machine learning model to a micrograph 102 received at operation 412a to detect the clusters 106 of dendrite arms 107 from the micrograph 102. This allows the machine learning model to generate the image frame 104. At operation 414, via application of the watershed algorithm to the image frame 104, the method 400 includes detecting the individual dendrite arms 107 within the clusters 106 of dendrite arms 107. At operation 414a, the method 400 includes separating and quantifying the individual dendrite arms 107 within the clusters 106 of dendrite arms 107 that overlap or touch. At operation 416, the method 400 includes applying at least one filter to the watershed image frame 108. For example, the method 400 includes at operation 416a, applying the distance filter 300a, the aspect ratio filter 300b, the angle filter 300c, the arm location filter 300d, and the quantity filter. An output is generated at operation 418. For example, at operation 418a, the method 400 generates the cluster profile 120 of at least one of the clusters 106 of dendrite arms 107 that satisfies the filters. The cluster profile 120 includes at least the average DAS 122 for at least one of the clusters 106 of dendrite arms 107 remaining after the at least one filter has been applied.

Data associated with the method 400 of generating the cluster profile 120 may be visualized at a graphical user interface (GUI) 500. The GUI 500 provides a filter specification interface 502 for a user to input filtering specifications based on each applicable filter. For example, the filter specification interface 502 may include a distance scale factor that is user configurable for the distance filter 300a. In another example, the filter specification interface 502 may include a maximum angle difference that is user configurable for the angle filter 300c. The filter specifications that are provided at the filter specification interface 502 may include less filter specifications or more filter specifications without deviating from the context of this disclosure.

The GUI 500 may also include an input image 504 that is representative of the micrograph 102. Further, the GUI 500 may also include an output image or display image 506 that identifies that at least one cluster 106 of dendrite arms 107 that is retained after filtering has been applied to the watershed image frame 108. For example, if the arm quantity filter is the final filter applied to the watershed image frame 108, the display image 506 is representative of the arm quantity filtered image frame 118.

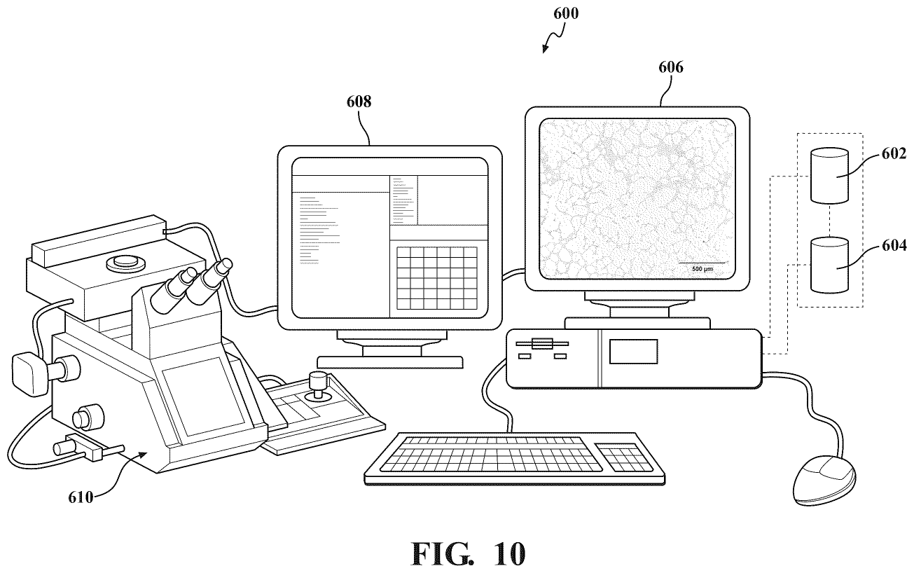

With reference to FIG. 10, a test environment 600 enables a user to perform the method 400 of generating the cluster profile 120 to determine at least the average DAS 122 for at least one of the clusters 106 of dendrite arms 107 remaining in the arm quantity filtered image frame 118 (assuming the arm quantity filter is the final filter applied to the watershed image frame 108). The test environment 600 includes memory hardware 602 storing instructions that, when executed on data processing hardware 604 in communication with the memory hardware 602, cause the data processing hardware 604 to perform operations associated with the method 400 of generating the cluster profile 120. A first monitor 606 may be provided to display frames associated with the method 400, such as the micrograph 102, the watershed image frame 108, the arm quantity filtered image frame 118, as well as all other frames associated with the method 400. Further, a second monitor 608 may be provided to display the GUI 500 for a user to input filtering specifications at the filter specification interface 502, as well as view the input image 504 and the display image 506. The test environment 600 may also include a microscope 610 for purposes of reading and magnifying the micrograph 102. Magnifying the micrograph 102 at the microscope 610 allows the micrograph 102 to be digitally displayed at one or both of the first monitor 606 and the second monitor 608. In this regard, the test environment 600 enables all operations associated with the method 400.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
via application of a machine learning algorithm to a micrograph representative of a metallic material:
detecting clusters of dendrite arms in the metallic material; and
generating an image frame based on the micrograph and representative of the clusters of dendrite arms;
detecting, via application of a watershed algorithm to the image frame, individual dendrite arms within the clusters of dendrite arms;
applying at least one filter to the image frame;
identifying at least one cluster of dendrite arms in the image frame that satisfies the at least one filter; and
generating, for the at least one cluster of dendrite arms, a cluster profile including at least an average dendrite arm spacing (DAS) value for the at least one cluster of dendrite arms.

2. The method of claim 1, wherein the at least one filter includes a distance filter requiring distances between each pair of adjacent dendrite arms of the at least one cluster of dendrite arms be between a minimum distance and a maximum distance.

3. The method of claim 1, wherein the at least one filter includes an aspect ratio filter requiring an aspect ratio of each individual dendrite arm within the at least one cluster of dendrite arms be greater than a minimum aspect ratio.

4. The method of claim 1, wherein the at least one filter includes an angle filter requiring angles between each pair of adjacent dendrite arms of the at least one cluster of dendrite arms be less than a maximum angle.

5. The method of claim 1, wherein the at least one filter includes a location filter requiring each individual dendrite arm within the at least one cluster of dendrite arms be positioned relative to the other dendrite arms of the at least one cluster of dendrite arms between a first bound and a second bound.

6. The method of claim 1, wherein the at least one filter includes a quantity filter requiring that the at least one cluster of dendrite arms includes at least a minimum number of individual dendrite arms.

7. The method of claim 1, wherein the cluster profile further includes at least one selected from the group consisting of (i) a number of the at least one cluster of dendrite arms, (ii) a number of individual dendrite arms within each of the at least one cluster of dendrite arms, (iii) a width of each of the at least one cluster of dendrite arms, and (iv) an average angle of individual dendrite arms within each of the at least one cluster of dendrite arms.

8. The method of claim 1, wherein the cluster profile further includes a display image identifying the at least one cluster of dendrite arms.

9. The method of claim 1, wherein the at least one filter is configurable based on a user input.

10. The method of claim 1, wherein the machine learning algorithm is trained based on a plurality of annotated micrographs.

11. A system comprising:
memory hardware storing instructions that, when executed on data processing hardware in communication with the memory hardware, cause the data processing hardware to perform operations comprising:
via application of a machine learning algorithm to a micrograph representative of a metallic material:
detecting clusters of dendrite arms in the metallic material; and
generating an image frame based on the micrograph and representative of the clusters of dendrite arms;
detecting, via application of a watershed algorithm to the image frame, individual dendrite arms within the clusters of dendrite arms;
applying at least one filter to the image frame;
identifying at least one cluster of dendrite arms in the image frame that satisfies the at least one filter; and
generating, for the at least one cluster of dendrite arms, a cluster profile including at least an average dendrite arm spacing (DAS) value for the at least one cluster of dendrite arms.

12. The system of claim 11, wherein the at least one filter includes a distance filter requiring distances between each pair of adjacent dendrite arms of the at least one cluster of dendrite arms be between a minimum distance and a maximum distance.

13. The system of claim 11, wherein the at least one filter includes an aspect ratio filter requiring an aspect ratio of each individual dendrite arm within the at least one cluster of dendrite arms be greater than a minimum aspect ratio.

14. The system of claim 11, wherein the at least one filter includes an angle filter requiring angles between each pair of adjacent dendrite arms of the at least one cluster of dendrite arms be less than a maximum angle.

15. The system of claim 11, wherein the at least one filter includes a location filter requiring each individual dendrite arm within the at least one cluster of dendrite arms be positioned relative to the other dendrite arms of the at least one cluster of dendrite arms between a first bound and a second bound.

16. The system of claim 11, wherein the at least one filter includes a quantity filter requiring that the at least one cluster of dendrite arms include at least a minimum number of individual dendrite arms.

17. The system of claim 11, wherein the cluster profile further includes at least one selected from the group consisting of (i) a number of the at least one cluster of dendrite arms, (ii) a number of individual dendrite arms within each of the at least one cluster of dendrite arms, (iii) a width of each of the at least one cluster of dendrite arms, and (iv) an average angle of individual dendrite arms within each of the at least one cluster of dendrite arms.

18. The system of claim 11, wherein the cluster profile further includes a display image identifying the at least one cluster of dendrite arms.

19. The system of claim 11, wherein the at least one filter is configurable based on a user input.

20. The system of claim 11, wherein the machine learning algorithm is trained based on a plurality of annotated micrographs.
